(19) United States
(12) Patent Application Publication
(10) Pub. No.: US 2008/0229184 A1
(43) Pub. Date: Sep. 18, 2008

(54) Private sheets in shared spreadsheets

(75) Inventors: Shahar Prish, Redmond, WA (US); Eran Megiddo, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/724,988

(22) Filed: Mar. 15, 2007

(51) Int. Cl. G06F 17/00; G06F 17/30

(52) U.S. Cl. 715/212; 726/30; 715/216

(57) ABSTRACT

Private sheets are disclosed, in shared computer applications, such as spreadsheets. In one aspect, a public sheet is accessible to a first client and a second client; and, moreover, a private sheet is accessible only to the second client. The private sheet is configured to access content in the public sheet, but the public sheet can't access content in the private sheet. In this way, users can use private sheets to perform calculations or modeling on the side, while collaborating on public sheets with other users. In another aspect, changes made to the public sheet can be reflected in the private sheet, if such changes are referenced by the private sheet to content in the public sheet. However, changes made to the private sheet are not reflected in the public sheet. Numerous other specific aspects are also disclosed, such as private sheets accessing values but not formulas from public sheets.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright ©2006, 2007 Microsoft Corp.

### FIELD OF TECHNOLOGY

The presently disclosed subject matter relates (but is by no means limited) to the field of computing, and more particularly, to field of spreadsheet applications.

### BACKGROUND

Spreadsheet applications give users the ability to easily jot down quick calculations that help them think about what-if scenarios or some simple micro-modeling, such as information verification inside their actual data. When spreadsheets are placed on servers in order to allow people to edit them in a collaborative way, such edits can potentially conflict with one another. Moreover, it is common for users to use an area to the left or right of the actual data as a scratch pad. When collaborating, that information is also shared, adding potential “noise” to the other users.

Thus, it would be advantageous to have a “private” area that behaves just like the rest of the spreadsheet (allowing calculations, etc.) but that is not visible or accessible to the rest of the workbook. It would further be advantageous to have a private area that can be used as the scratch pad, leveraging all the power of working with spreadsheets, however, but without propagating data to the rest of the users.

### SUMMARY

In various aspects disclosed herein, systems, methods, computer readable media and the like are disclosed for providing private areas (or in one non-limiting example, “sheets”) in shared computer applications, such as spreadsheets. For example, in one aspect, a public sheet is accessible to a first client and a second client; and, moreover, a private sheet is accessible only to the second client (out of the first and second client). The private sheet is configured to access content in the public sheet but the public sheet is prevented from accessing content in the private sheet. In this way, users can use private sheets to perform calculations or modeling on the side while collaborating on public sheets with other users.

In another aspect, changes made to the public sheet can be reflected in the private sheet if such changes are referenced by the private sheet to content in the public sheet. For instance, a value that changes in the public sheet will correspondingly change in the private sheet if such value is marked or referenced by the private sheet for updating. However, changes made to the private sheet are not reflected in the public sheet, since private changes by individual users should have no effect on a publicly collaborative effort by the remaining set of users.

In still other aspects, the public sheet can reside on a server configured to serve the first and the second client. Thus, clients having their own private sheets can conduct a collaborative session using a server hosting a public sheet. Alternatively, however, just as easily the disclosed subject matter could be implemented on a peer-to-peer network (in contrast to the client-server network). Whatever the ultimate implementation, various other details can be used in other aspects. For example, the private sheet can be invisible to the first client, in addition to being inaccessible to the first client (per the discussion above). Depending on the application, the public sheet and the private sheet can be part of the same spreadsheet application. And as such, certain rules can be enforced, such as configuring the private sheet to access values but not formulas from the public sheet.

It should be noted that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are illustrated. However, the disclosure is not limited to the specific aspects shown. The following figures are included:

FIG. 1 illustrates a prior art system wherein clients can collaborate on an application by using a common meeting point, such as server;

FIG. 2 illustrates an additional detail aspect of FIG. 1, where cells within sheets can create various references, dependencies, and access points to other cells;

FIG. 3 illustrates that certain sheets within workbooks may be visible and/or accessible only to some clients but not to others;

FIG. 4 illustrates that clients can make changes to their own private sheets and to any public sheets, but not to each others' private sheets;

FIG. 5 illustrates how changes, discussed with reference to FIG. 4, are affected between private and public sheets, that is, FIG. 5 (especially in conjunction with FIG. 6) demonstrates how the flow of influence between such sheets is asymmetrical;

FIG. 6 illustrates, in contrast to FIG. 5, that changes in private sheets may not have influence on content in public sheets;

FIG. 7 illustrates the location of private sheet storage and execution in a typical network environment;

FIG. 8 illustrates a scenario involving a peer-to-peer network for one exemplary and non-limiting aspect of the presently disclosed subject matter (in contrast to the aspect shown in FIG. 1 having a client-server architecture, which may be used in other aspects of the presently disclosed subject matter);

FIG. 9 illustrates in block diagram form a flow chart for one exemplary and non-limiting implementation of the presently disclosed subject matter;

FIG. 10 illustrates an exemplary PC to be used in conjunction with various aspects of the presently disclosed subject matter; and

FIG. 11 illustrates an exemplary networking environment wherein a spreadsheet application could be shared between multiple PCs shown in FIG. 9.

### DETAILED DESCRIPTION

### Introduction and Overview

In this Detailed Description, an exemplary and non-limiting aspect of the presently disclosed subject matter is explored in detail. However, this aspect, focusing on private sheets in the context of spreadsheets, is not limited to “sheets” or “spreadsheets.” Those of ordinary skill in the art will readily appreciate that “pages” and “word processing programs” could have just as easily been discussed, or “palettes” and “drawing/drafting programs,” and so on. The presently disclosed subject matter is applicable to just about any computer application. However, for brevity's sake and to efficiently concretize the presently disclosed subject matter, various aspects of private sheets in spreadsheets are discussed below.

Thus, disclosed herein are private sheets in computer programs, namely, spreadsheets. According to one aspect discussed in detail below, a public sheet is accessible to a first client and a second client. Moreover, a private sheet is accessible only to the second client. The private sheet is configured to access content in the public sheet, but the public sheet can't access content in the private sheet. In this way, users can use private sheets to perform calculations or modeling on the side, while collaborating on public sheets with other users. According to another aspect, also explored in detail, below, changes made to the public sheet can be reflected in the private sheet, if such changes are referenced by the private sheet to content in the public sheet. However, changes made to the private sheet are not reflected in the public sheet. Numerous other specific aspects are also disclosed, such as private sheets accessing values but not formulas from public sheets.

### Aspects of Private Sheets in Spreadsheets

In the context of spreadsheets, an application “workbook” can be a file that contains one or more “worksheets,” which can be used to organize various kinds of related information. Data can be entered and edited on several worksheets simultaneously, and calculations can be performed based on data from more than one worksheet. For instance, when a chart is created, the chart can be placed on the same worksheet as its related data or on a separate chart sheet. Those of skill in the art will readily appreciate the various permutations a typical spreadsheet program can take, given concepts such as “sheets,” “workbooks,” and the like.

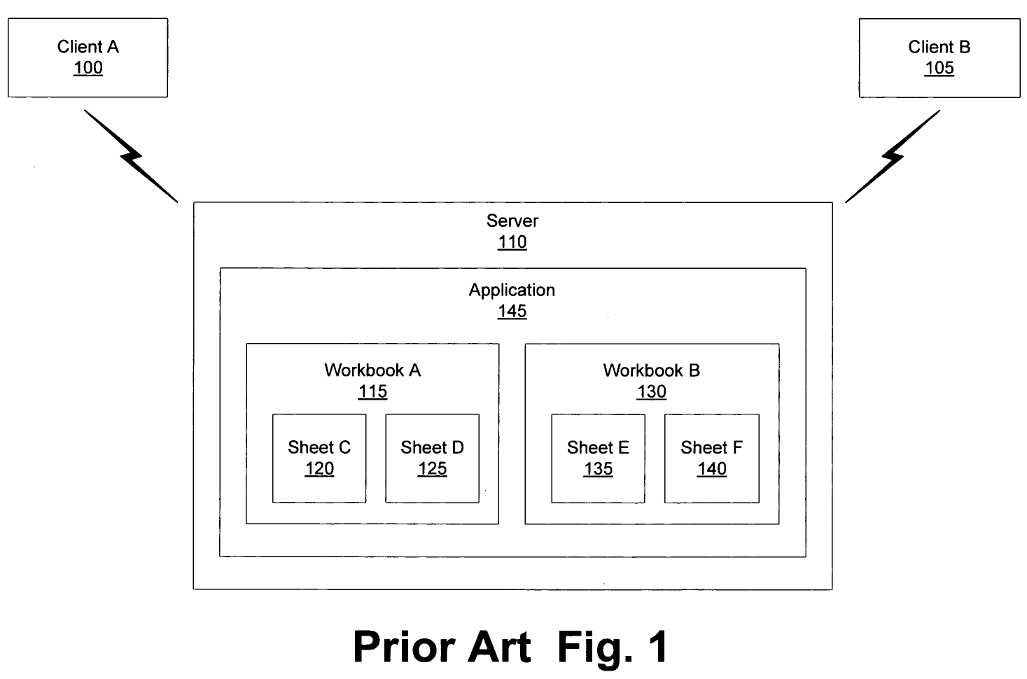

Turning now to the first figure, FIG. 1 illustrates a prior art system wherein clients can collaborate on an application by using a common meeting point, such as server. Specifically, client A 100 can communicate via some network (see below for an extensive discussion regarding the types of networks contemplated herein) with a server 110. It should be noted that this client A 100 can not only be a personal computer (PC), but just about any computing device, such as a handheld, cell phone, etc. (an extensive discussion is provided below as to the type of computing devices that are contemplated herein).

Another client, namely, client B 105 can also communicate with this server 110. Thus, in this way, both clients A 100 and B 105 can collaborate on some project by “meeting” on the server 110. For instance, clients A 100 and B 105 can collaborate on an application 145 running on the server 110. This application 145, may have a plurality of workbooks and a plurality of sheets with these workbooks. Specifically, a workbook A 115 can have sheets C 120 and D 125, and a workbook B 130 can have sheets E 135 and F 140. Clients A 100 and B 105 can work together or independently on any of these workbooks 115, 130 and the sheets 120, 125, 135, 140 residing therein.

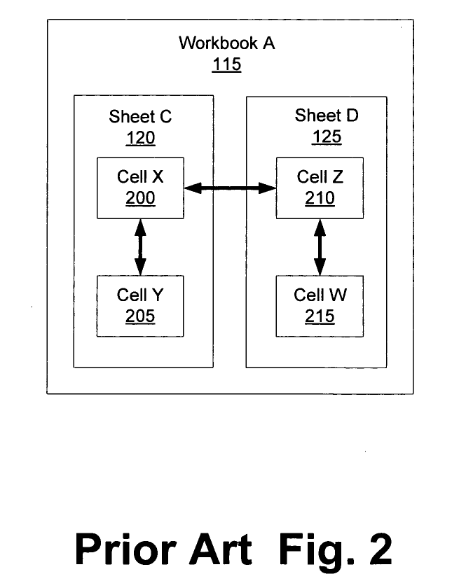

Furthermore, FIG. 2 illustrates an additional detail aspect of FIG. 1, where cells within sheets can create various references, dependencies, and access points to other cells. As these terms are used herein, “references,” “dependencies,” and “access,” they are understood to broadly convey a variety of relationships cells can with one another. For instance, a value in one cell of a first sheet, can depend on the value of a second cell in a second sheet. Similarly, cells can reference other cells for values (or other content, such as formulas). In any event, those of skill in the art will readily appreciate, given the appropriate context, what these terms mean. In other words, they are not given herein any special limited meaning, but on the contrary, they encompass a variety of scenarios that users typically engage in while using computing programs, such as spreadsheets.

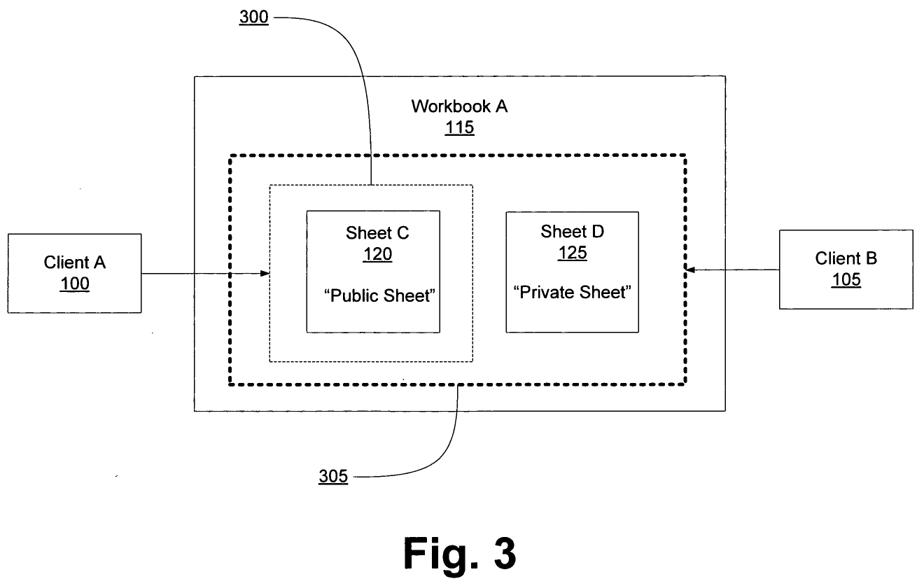

Next, FIG. 3 illustrates that certain sheets within workbooks may be visible and/or accessible only to some clients but not to others. In FIG. 3, client A 100 can see and/or access sheet C 120. This sheet 120 is a “public sheet” because it can be seen and/or accessed by other clients. It should be noted that sheets may be (1) seen or not seen and/or (2) accessed or not accessed. In the former scenario, allowing others to see private sheets—see in the sense such private sheets are there, but not allowing users to read contents thereof—but not being able to access them, e.g. edit them, may not be as useful as not showing them in the first place—but that much is an implementation detail, depending on the need of uses. In the latter scenario, “access” is understood to at least entail the ability to read and/or to write data. But, it could also mean (but is not restricted to) being able to procure values and/or formulas from cells.

In contrast to sheet C 120, sheet D 125 is only seen and/or accessible by client B 105. In fact, both sheet C 120 and sheet D 125 are seen and/or accessible to client B 105. However, client A 100 can only see and/or access sheet C 120. The dashed lines 300, 305 are meant to illustrate this notion, since the inner dashed line 300 confines client A 100 sight and/or access to sheet C 120, while the outer dashed line 105 allows client B 105 to see and/or access both sheets 120, 125.

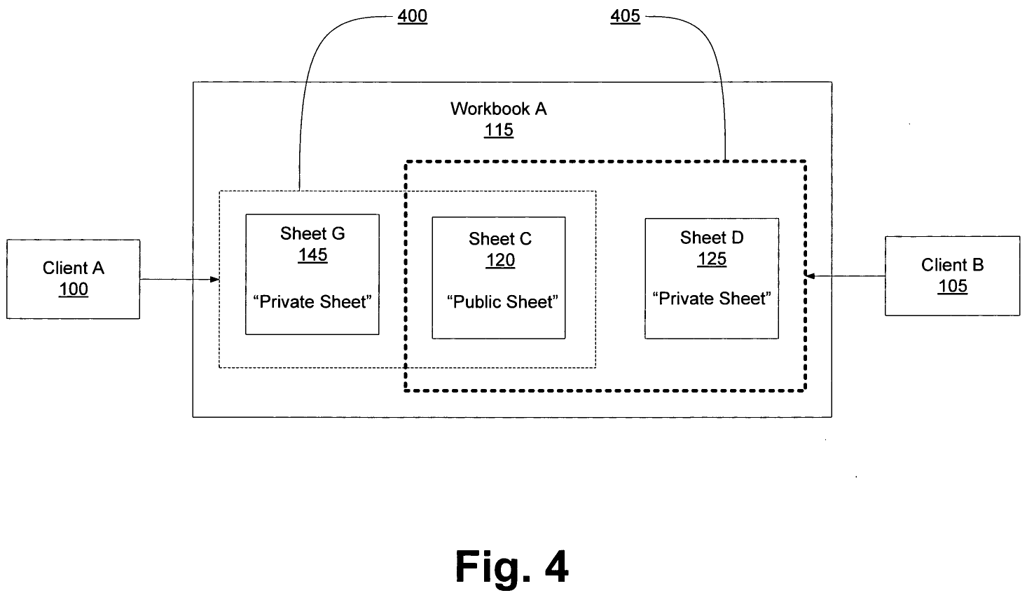

Next, FIG. 4 illustrates that clients can make changes to their own private sheets and to any public sheets, but not to each others' private sheets. In FIG. 4, client A 100 can make changes (i.e. modifications, such as writing) to sheet G 145, that client's 100 private sheet, and additionally, the public sheet C 120. Similarly, client B 105 can makes changes to its own private sheet D 125 and to its public sheet C 120. However, client A 100 cannot make changes to client B's 105 private sheet D 125, and correspondingly, client B 105 cannot make changes to client A's 100 private sheet G 145. Of course, it is understood, per the discussion above, that such limitation may not only extend to changes, but also to the ability of the clients to merely read the others' private pages, or even to the knowledge such others have private pages to begin with. The level of security and privacy for private sheets 145, 125 may be set per user and/or system and/or application specifications. In any event, the dashed boxes 400, 405, as before attempt to delimit the scope of operability of the clients: client A 100 has operability over sheets G 145 and C 120, while client B 105 has operability over sheets C 120 and D 125.

It should also be noted that private sheets may or may not be persisted. In other words, they may be true scratch-pads that are deleted when users are done with a particular task, session, or workbook. On the other hand, private sheets may also be deemed important or relevant enough to be retained and become integrated as an integral part of a given workbook.

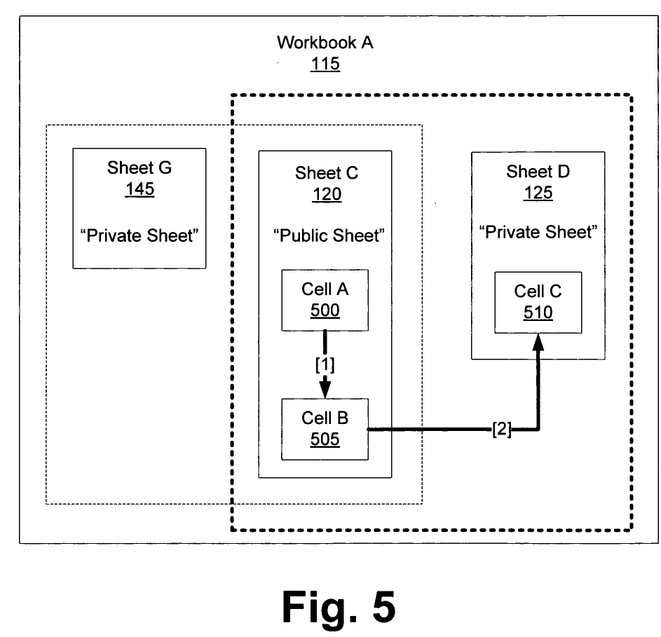

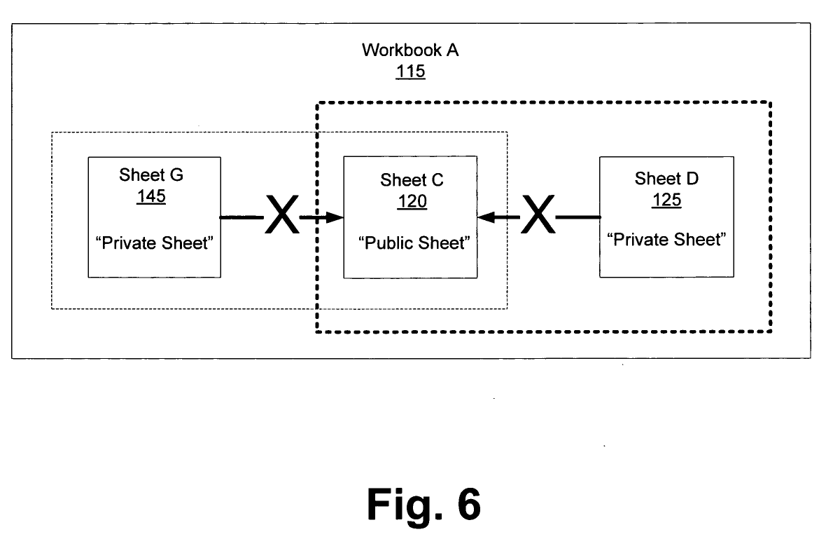

Next, FIG. 5 illustrates how changes, discussed with reference to FIG. 4, are affected between private and public sheets, that is, FIG. 5 (especially in conjunction with FIG. 6) demonstrates how the flow of influence between such sheets is asymmetrical. This means that, for example, changes in public sheets may permeate down to private pages, if it is so desired, but changes in private sheets may not permeate down to public sheets. FIG. 5 shows that cell A 500 in the public sheet C 120 of workbook A 115, may have some effect (shown by the [1] arrow) on another cell within its scope (i.e. a cell B 505 also within sheet C 120). If cell B 505 is affected by cell A 500, then FIG. 5 shows that cell C 510 in a private sheet may also be affected by cell B 505 (shown by the [2] arrow). This may happen when cell C 510 references cell B 505 for its value, for example.

To provide one concrete scenario, cell A 500 can initially have a value of “100” (not shown), and cell B 505 can take this value and multiply it by two to obtain “200,” and furthermore, cell C 510 can in turn take this value and add some other value, say, one, to obtain a final result of “201.” Now, if cell A 500 changes its value to, say, “10,” then cell B 505 would accordingly changes its value to “20,” and cell C 510 would change its value to “21.” The point here is that changes in public sheets, such as sheet C 120, may have an effect on values in some private sheets, such as sheet D 125 (and yet have no effect on other private sheets, such as sheet G 145).

In contrast to FIG. 5, FIG. 6 illustrates that changes in private sheets may not have influence on content in public sheets. Thus, sheet G 145, which may be some user's private sheet is shown as not having an influence (or not having the ability to change data) in public sheets, such as sheet C 120. Similarly, other private sheets (sheet D 125) from other users collaborating on sheet C 120, are also prevented from changing content in sheet C 120. There may be various reasons for doing so, one being that data in a pubic space 120 should not be subject to change from a place 145, 125 where only one user from a plurality of users has access. In any event, the arrows with “X”s (—X→ and ←X—are meant to illustrate this notion visually). It should be noted, that the kind of changes that are prevented from being implemented in this context may not only include values, but also formulas.

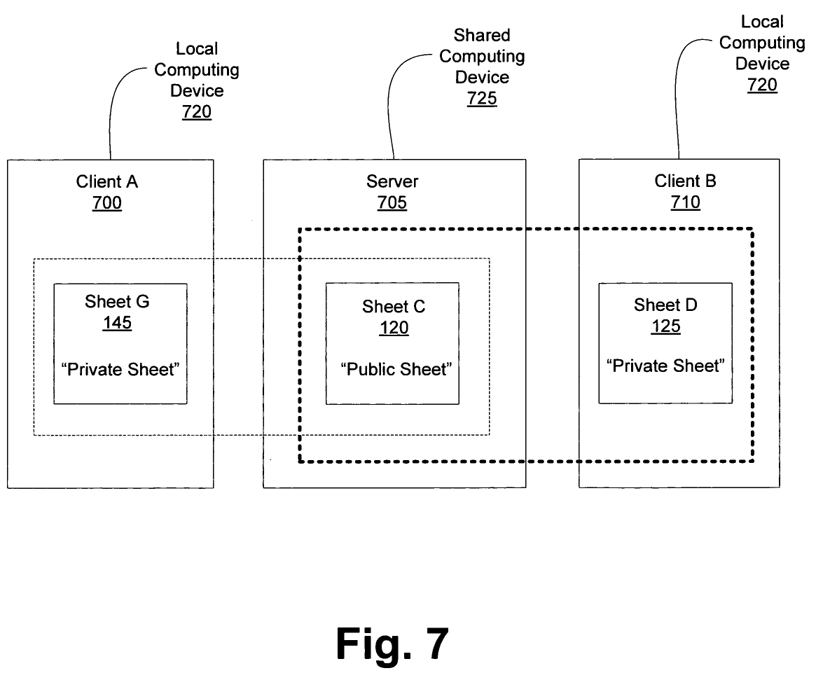

In another aspect of the presently disclosed subject matter, FIG. 7 illustrates the location of private sheet storage and execution in a typical network environment. As was discussed already with reference to FIG. 1, in a typical collaborating scenario, there may be a server that allows a plurality of clients to collaborate on some project. With the introduction of private sheets (in addition to public sheets), a questions arises as to where such private sheets should get stored and executed. In one scenario, such private sheets are stored and/or executed locally on their clients, while any public sheets get stored on the server side.

Turning now to FIG. 7, it can be seen that sheet G 145, which is a private sheet, is stored on (or resides on and/or executes on) client A 700, the local computing device 720 for a user. Similarly, private sheet D 125 is stored on (or resides on and/or executes on) client B 710, the local computing device 720 for another user. The shared computing device 725 between any collaborating users, namely the server 705, stores and/or executes any public sheets, such as sheet C 120. Thus, in short, in this aspect, private sheets are stored on and/or execute on local computing devices (clients), while public sheets are stored on and/or execute on shared computing devices (servers).

However, even though this may be the preferred embodiment of the presently disclosed subject matter, one could just as easily image that private sheets got also stored on shared computing devices—although, in such scenarios, safety mechanisms would need to be implemented to would ensure that users could not see and/or modify each others' private sheets. Moreover, in peer-to-peer networks, public sheets would, technically speaking, be stored in local computing devices, since servers would not be used as meeting places for collaboration (although servers could certainly be used in routing/gateway capacity).

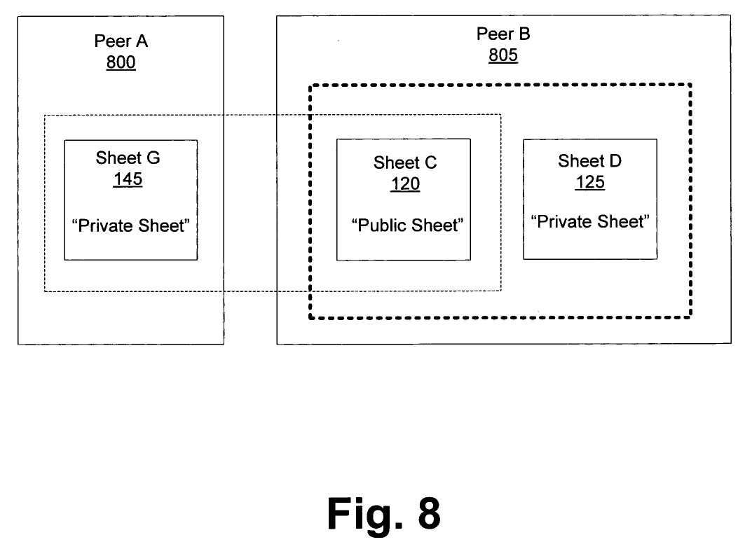

In fact, FIG. 8 illustrates a scenario involving a peer-to-peer network for one exemplary and non-limiting aspect of the presently disclosed subject matter (in contrast to the aspect shown in FIG. 1 having a client-server architecture, which may be used in other aspects of the presently disclosed subject matter). In FIG. 8, private sheet G 145 may reside on/execute on peer computing device A 800, while private sheet D 125 and public sheet C 120 both reside on/execute on peer computing device B 805. Of course, those of skill in the art will readily recognize other architectural scenarios (to that of client-server and peer-to-peer scenarios) for the presently disclosed private sheet/public sheet subject matter. For instance, hybrid peer-to-peer setups may be used, where a central server keeps information on peers and responds to requests for that information, but where peers are responsible for hosting available resources (as the central server does not have them), for letting the central server know what resources they want to share, and for making its shareable resources available to peers that request it.

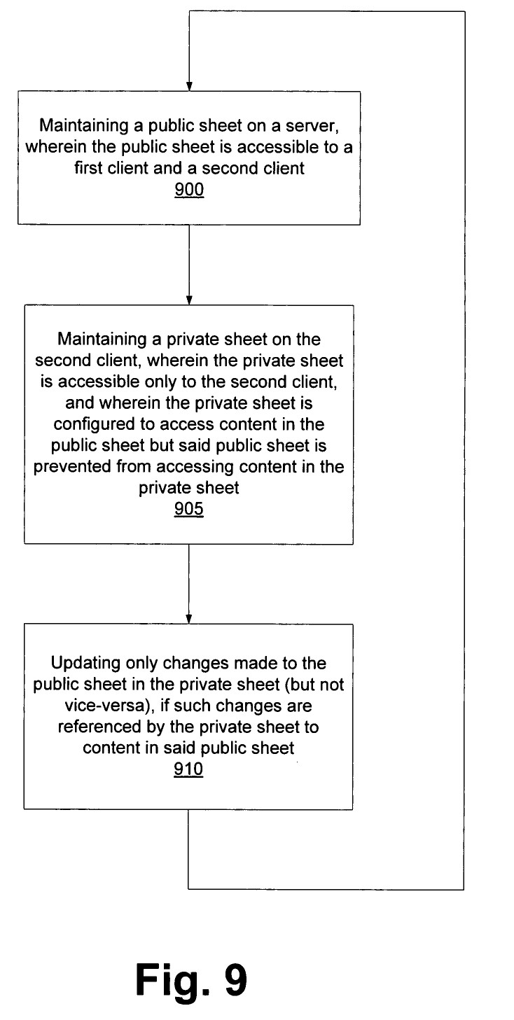

FIG. 9 illustrates in block diagram form a flow chart for one exemplary and non-limiting implementation of the presently disclosed subject matter. Starting at block 900, a public sheet on a server is maintained, wherein the public sheet is accessible to a first client and a second client. Then, at block 905, a private sheet is maintained on the second client, wherein the private sheet is accessible only to the second client of the first client and the second client, and wherein the private sheet is configured to access content in the public sheet, but the public sheet is prevented from accessing content in the private sheet. This may be deemed asymmetrical accessibility between private and public sheets.

Next, at block 910, changes made to the public sheet are updated in the private sheet (but the opposite is not true, as was explained in detail, above), if such changes are referenced by the private sheet to content in the public sheet. This scenario was already discussed above with reference to FIG. 5, where changes in public sheets permeated down to private sheets, since such changes were reference on a cell level. For instance, a change in cell X in a public sheet can be updated in cell Y in a private sheet, since the private sheet cell value may depend on the public sheet value. In some aspects, such referencing may be limited to values only, in others it may also include formulas. Still in other aspects, formulas may be explicitly excluded—i.e. private sheets can access values but not formulas from such a public sheet.

It was already noted that any changes made to the private sheet could be prevented from permeating to the public sheet. This notion is captured in block 910 by “only” updating changes made to the public sheets, but not vice versa. This general mechanism of maintaining and updating may be performed continuously, as is shown by the feedback arrow from block 910 back to block 900. Lastly, the public sheet and the private sheet could be hosted as part of a spreadsheet application, however, as was explained above, such hosting is not limited to spreadsheet application, but in fact is open to just about any other computing application, such as a word processing program having pages, or a drawing program having palettes, and so on.

Exemplary PC and Networking Aspects for Use with Spreadsheets

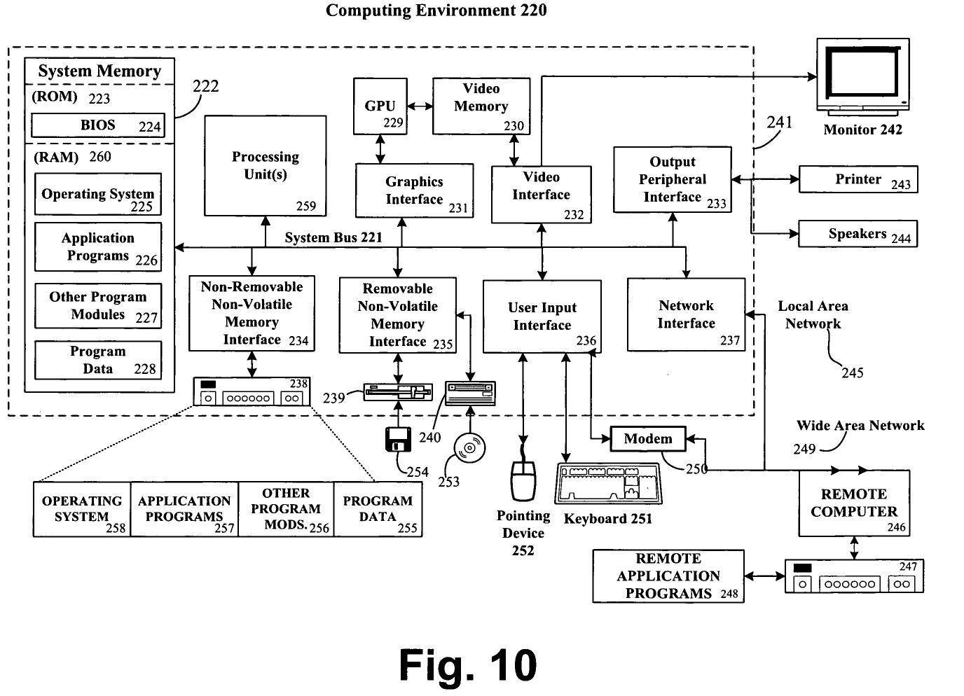

Next, turning to FIG. 10, shown is a block diagram representing an exemplary computing device suitable for use in conjunction with implementing the subject matter disclosed above. For example, the computer executable instructions that carry out the processes and methods for providing private sheets in spreadsheet may reside and/or be executed in such a computing environment as shown in FIG. 10. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220.

Aspects of the presently disclosed subject matter are operational with numerous other general purpose or special purpose computing system environments or configurations. Examples of well known computing systems, environments, and/or configurations that may be suitable for use with the this subject matter include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the presently disclosed subject matter may be implemented in the general context of computer-executable instructions, such as program modules, being executed by a computer. Generally, program modules include routines, programs, objects, components, data structures, etc. that perform particular tasks or implement particular abstract data types. Aspects of the presently disclosed subject matter may also be practiced in distributed computing environments where tasks are performed by remote processing devices that are linked through a communications network. In a distributed computing environment, program modules may be located in both local and remote computer storage media including memory storage devices.

An exemplary system for implementing aspects of the presently disclosed subject matter includes a general purpose computing device in the form of a computer 241. Components of computer 241 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 10 illustrates operating system 225, application programs 226, other program modules 227, and program data 228.

The computer 241 may also include other removable/non-removable, volatile/nonvolatile computer storage media. By way of example only, FIG. 10 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 10, provide storage of computer readable instructions, data structures, program modules and other data for the computer 241. In FIG. 10, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 10. The logical connections depicted in FIG. 10 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 10 illustrates remote application programs 248 as residing on memory device 247. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the presently disclosed subject matter, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the said subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

In light of the diverse computing environments that may be built according to the general framework provided in FIG. 10, the systems and methods provided herein cannot be construed as limited in any way to a particular computing architecture. Instead, the presently disclosed subject matter should not be limited to any single embodiment, but rather should be construed in breadth and scope in accordance with the appended claims.

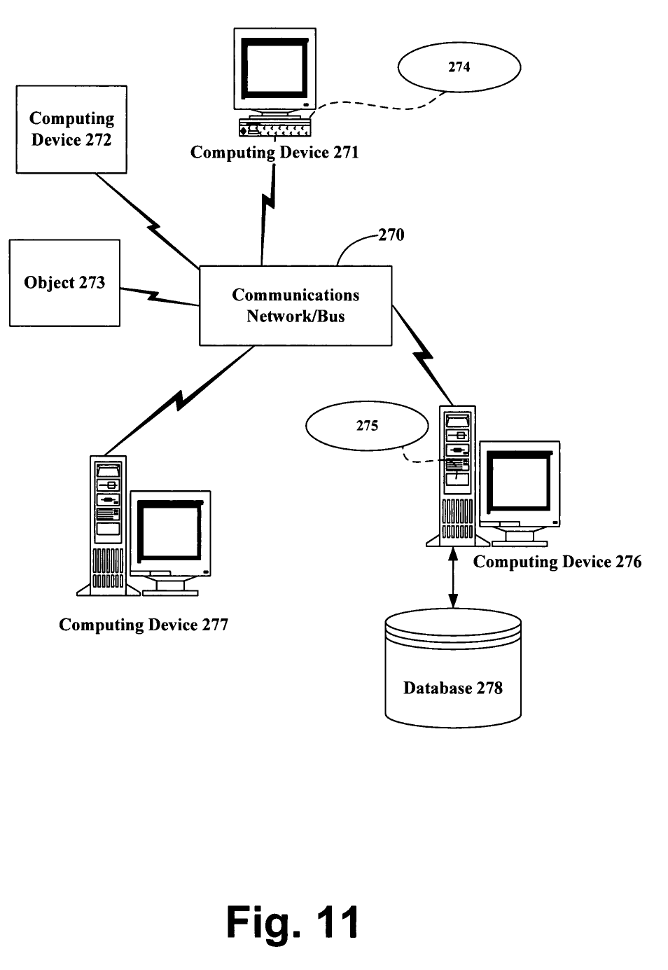

Finally, referring to FIG. 11, shown as an exemplary networked computing environment in which many computerized processes may be implemented to perform the processes described above. That is, this network environment may allow user to collaborate on a variety of projects discussed above. For example, parallel computing may be part of such a networked environment with various clients on the network of FIG. 11 using and/or implementing the defining and extracting of a flat list of search properties from a rich structured type. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 11 provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 3, and may itself represent multiple interconnected networks. In accordance with an aspect of the presently disclosed subject matter, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 11, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 11 and the further diversification that can occur in computing in a network environment such as that of FIG. 11, the systems and methods provided herein cannot be construed as limited in any way to a particular computing architecture or operating system. Instead, the presently disclosed subject matter should not be limited to any single embodiment, but rather should be construed in breadth and scope in accordance with the appended claims.

Finally, it should also be noted that the various techniques described herein may be implemented in connection with hardware or software or, where appropriate, with a combination of both. Thus, the methods, computer readable media, and systems of the presently disclosed subject matter, or certain aspects or portions thereof, may take the form of program code (i.e., instructions) embodied in tangible media, such as floppy diskettes, CD-ROMs, hard drives, or any other machine-readable storage medium, where, when the program code is loaded into and executed by a machine, such as a computer, the machine becomes an apparatus for practicing the subject matter.

In the case of program code execution on programmable computers, the computing device may generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

Lastly, while the present disclosure has been described in connection with the preferred aspects, as illustrated in the various figures, it is understood that other similar aspects may be used or modifications and additions may be made to the described aspects for performing the same function of the present disclosure without deviating therefrom. For example, in various aspects of the disclosure, the private sheets in spreadsheets were discussed. However, other equivalent mechanisms to these described aspects are also contemplated by the teachings herein. Therefore, the present disclosure should not be limited to any single aspect, but rather construed in breadth and scope in accordance with the appended claims.

What is claimed:

1. A system for providing private areas in shared computer applications, comprising:
a public sheet, wherein said public sheet is accessible to a first client and a second client; and
a private sheet, wherein said private sheet is accessible only to said second client of said first client and said second client, and wherein said private sheet is configured to access content in said public sheet but said public sheet is prevented from accessing content in said private sheet.

2. The system according to claim 1, wherein changes made to said public sheet are reflected in said private sheet if such changes are referenced by said private sheet to content in said public sheet.

3. The system according to claim 1, wherein changes made to said private sheet are not reflected in said public sheet.

4. The system according to claim 1, wherein said public sheet resides on a server configured to serve said first client and said second client.

5. The system according to claim 1, wherein said private sheet resides on said second client.

6. The system according to claim 1, wherein said first client and said second client are part of a peer-to-peer network.

7. The system according to claim 1, wherein said private sheet is invisible to said first client, in addition to being inaccessible to said first client.

8. The system according to claim 1, wherein said public sheet and said private sheet are part of the same spreadsheet application.

9. A method for providing private areas in shared computer applications, comprising:
maintaining a public sheet on a server, wherein said public sheet is accessible to a first client and a second client; and
maintaining a private sheet on said second client, wherein said private sheet is accessible only to said second client of said first client and said second client, and wherein said private sheet is configured to access content in said public sheet but said public sheet is prevented from accessing content in said private sheet.

10. The method according to claim 9, further comprising updating changes made to said public sheet in said private sheet if such changes are referenced by said private sheet to content in said public sheet.

11. The method according to claim 9, further comprising preventing the updating of any changes made to said private sheet in said public sheet.

12. The method according to claim 9, further comprising preventing said private sheet from being visible to said first client.

13. The method according to claim 9, further comprising hosting said public sheet and said private sheet as part of at least one spreadsheet application.

14. The method according to claim 9, further comprising configuring said private sheet to access values but not formulas from said public sheet.

15. A computer readable medium bearing computer executable instructions tangibly resident on a computing system, wherein said instructions provide private areas in shared computer applications, comprising:
a first instruction that maintains a public sheet on a server, wherein said public sheet is accessible to a first client and a second client; and
a second instruction that maintains a private sheet on said second client, wherein said private sheet is accessible only to said second client of said first client and said second client, and wherein said private sheet is configured to access content in said public sheet but said public sheet is prevented from accessing content in said private sheet.

16. The computer readable medium according to claim 15, further comprising a third instruction that updates changes made to said public sheet in said private sheet if such changes are referenced by said private sheet to content in said public sheet.

17. The computer readable medium according to claim 15, further comprising a fourth instruction that prevents the updating of any changes made to said private sheet in said public sheet.

18. The computer readable medium according to claim 15, further comprising a fifth instruction that prevents said private sheet from being visible to said first client.

19. The computer readable medium according to claim 15, further comprising a sixth instruction that allows for hosting said public sheet and said private sheet as part of at least one spreadsheet application.

20. The computer readable medium according to claim 15, further comprising a seventh instruction that configures said private sheet to access values but not formulas from said public sheet.
